(19) United States
(12) Patent Application Publication
(10) Pub. No.: US 2014/0091970 A1
(43) Pub. Date: Apr. 3, 2014

(54) ANTENNA WITH FREQUENCY SELECTIVE STRUCTURE

(71) Applicants: Yen-Hao Yu, Taipei City (TW); Chieh-Tsao Hwang, Taipei City (TW); Shih-Chia Liu, Taipei City (TW)

(72) Inventors: Yen-Hao Yu, Taipei City (TW); Chieh-Tsao Hwang, Taipei City (TW); Shih-Chia Liu, Taipei City (TW)

(73) Assignee: COMPAL ELECTRONICS, INC., Taipei City (TW)

(21) Appl. No.: 13/971,843

(22) Filed: Aug. 21, 2013

Related U.S. Application Data
(60) Provisional application No. 61/708,643, filed on Oct. 2, 2012.

(51) Int. Cl. H01Q 9/04

(52) U.S. Cl. CPC H01Q 9/0407
USPC 343/700 MS

(57) ABSTRACT

An antenna including a ground plane, a radiation element and a frequency selective structure is provided. The ground plane has a reflection area, and a first side edge of the reflection area is aligned with an edge of the ground plane. The radiation element is disposed near the first side edge of the reflection area and is operated at a resonant frequency. A width of the reflection area is related to a wavelength of the resonant frequency of the radiation element. The frequency selective structure is disposed on the ground plane along side edges of the reflection area except the first side edge and is adapted to reflect an electromagnetic wave from the radiation element.

### CROSS-REFERENCE TO RELATED APPLICATION

This application claims the priority benefits of U.S. provisional application Ser. No. 61/708,643, filed on Oct. 2, 2012. The entirety of the above-mentioned patent applications is hereby incorporated by reference herein and made a part of this specification.

### BACKGROUND OF THE INVENTION

1. Field of the Invention

The invention relates to an antenna and particularly to an antenna with a frequency selective structure.

2. Description of Related Art

In response to demands for higher transmission speed of wireless local area network (WLAN), a newly defined 802.11a/c communication standard has be introduced, which increases its transmission speed to almost 1 Gbps to accomplish up to three times the previous transmission speed. In addition, the 802.11a/c communication standard utilizes a high frequency band of 5 GHz. Accordingly, an electronic device needs to be disposed with an antenna capable of operating in the high frequency band, in order to support WLAN under the 802.11 a/c communication standard.

However, when the antenna is operated at the high frequency band, a wavelength of an electromagnetic wave radiated by the antenna is relatively shorter and easily affected by a ground plane. In this case, the antenna may cause a dead zone in receiving signals, and a reception quality thereof may be lowered accordingly. Therefore, how to improve an antenna radiation pattern is one of the most important topics to be discussed in designing the antenna.

### SUMMARY OF THE INVENTION

The present invention is directed to an antenna capable of improving a radiation pattern of a radiation element by disposing a frequency selective structure on a ground plane to improve reception quality thereof.

An antenna of the present invention includes a ground plane, a radiation element and a frequency selective structure. The ground plane has a reflection area, and a first side edge of the reflection area is aligned with an edge of the ground plane. The radiation element is disposed near the first side edge of the reflection area and is operated at a resonant frequency. A width of the reflection area is related to a wavelength of the resonant frequency of the radiation element. The frequency selective structure is disposed on the ground plane along side edges of the reflection area except the first side edge and is adapted to reflect an electromagnetic wave from the radiation element.

In an embodiment of the present invention, the width of the reflection area is between a one-sixteenth the wavelength of the resonant frequency to a one-fourth the wavelength of the resonant frequency, of the radiation element.

In an embodiment of the present invention, the frequency selective structure includes a plurality of frequency selective units. The frequency selective units are arranged along the side edges of the reflection area except the first side edge so as to form a periodic array. In addition, each of the frequency selective units includes a capacitive resonance and an inductive resonance, so as to be resonated at the resonant frequency of the radiation element.

In an embodiment of the present invention, the antenna is adapted to be disposed on an electronic device, and the ground plane is adapted to be disposed on a housing of the electronic device.

In summary, the frequency selective structure of the present invention is disposed on the ground plane along a part of the side edges of the reflection area, and the width of the reflection area is related to the wavelength of the resonant frequency of the radiation element. Accordingly, the antenna can improve the radiation pattern of the radiation element at the resonant frequency by using the frequency selective structure, so as to effectively improve the reception quality of the antenna.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic structural view of an antenna according to an embodiment of the present invention.

FIG. 2 is a radiation pattern diagram of an antenna according to an embodiment of the present invention.

FIG. 3 is a schematic enlarged view of the frequency selective structure depicted in FIG. 1.

### DESCRIPTION OF THE EMBODIMENTS

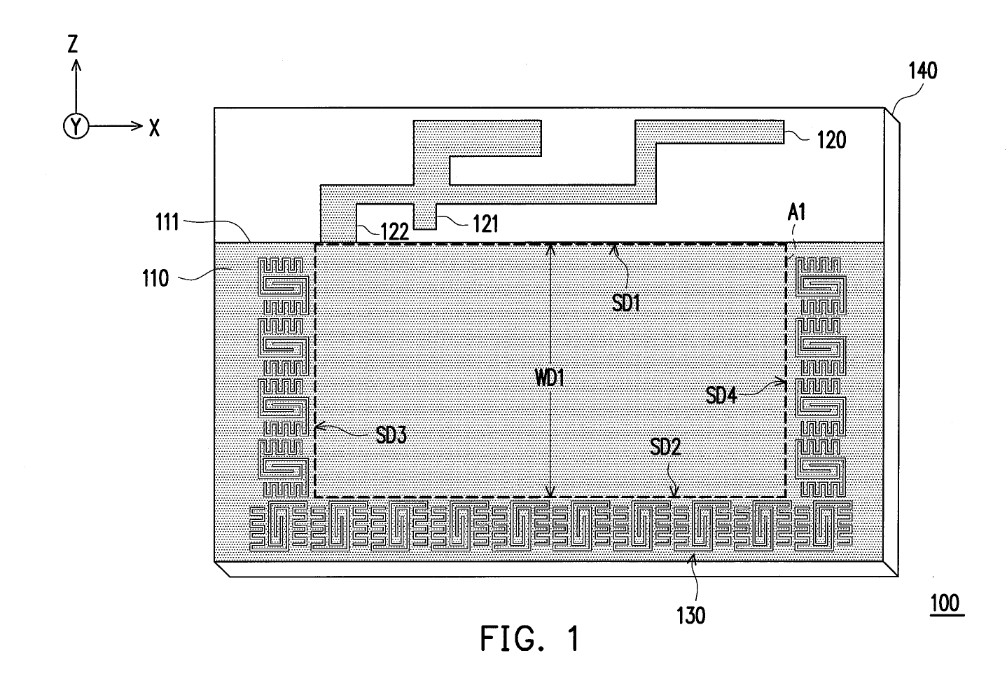

FIG. 1 is a schematic structural view of an antenna according to an embodiment of the present invention. Referring to FIG. 1, an antenna 100 includes a ground plane 110, a radiation element 120 and a frequency selective structure 130.

The radiation element 120 is near the ground plane 110. Further, an implementation of the radiation element 120 in the embodiment of FIG. 1 is illustrated as a radiation body of an inverted-F antenna, thus in the embodiment of FIG. 1, the radiation element 120 includes a feeding portion 121 and a ground portion 122. The ground portion 122 is electrically connected to the ground plane 110, and the feeding portion 121 receives a feeding signal, so as to excite the radiation element 120 to generate two resonant modes. Accordingly, the radiation element 120 can be at least operated at one resonant frequency (e.g., 5.15 GHz).

Furthermore, the ground plane 110 has a reflection area A1. The reflection area A1 includes a plurality of side edges SD1 to SD4. In addition, the side edge SD1 of the reflection area A1 is aligned with an edge 111 of the ground plane 110, and the reflection area 120 is near the side edge SD1 of the reflection area A1. Moreover, the frequency selective structure 130 is disposed on the ground plane 110 along the side edges SD2 to SD4 of the reflection area A1. That is, the frequency selective structure 130 is disposed on the ground plane 110 along the side edges SD2 to SD4 of the reflection area A1 except the side edge SD1.

In other words, the frequency selective structure 130 is surrounded below the radiation element 210, and the reflection area A1 of the ground plane 110 is completely surrounded by the frequency selective structure 130 and the radiation element 120. In addition, a distance between the frequency selective structure 130 and the radiation element 120 is mainly depended on a width WD1 of the reflection area A1. In the configuration, the width WD1 of the reflection area A1 is related to a wavelength of the resonant frequency (e.g., 5.15 GHz) of the radiation element 120. For instance, in an embodiment, the width WD1 of the reflection area A1 is between a one-sixteenth the wavelength of the resonant frequency to a one-fourth the wavelength of the resonant frequency, of the radiation element 120.

In addition, the frequency selective structure 130 is resonated at the resonant frequency (e.g., 5.15 GHz) of the radiation element 120. Accordingly, due to a filtering effect generated by the frequency selective structure 130, an electromagnetic wave radiated by the radiation element 120 at the resonant frequency (e.g., 5.15 GHz) cannot pass through the frequency selective structure 130. In other words, the frequency selective structure 130 can reflect the electromagnetic wave from the radiation element 120, so as to change a current distribution of the ground plane 110, thereby improving a radiation pattern of the radiation element 120 at the resonant frequency (e.g., 5.15 GHz).

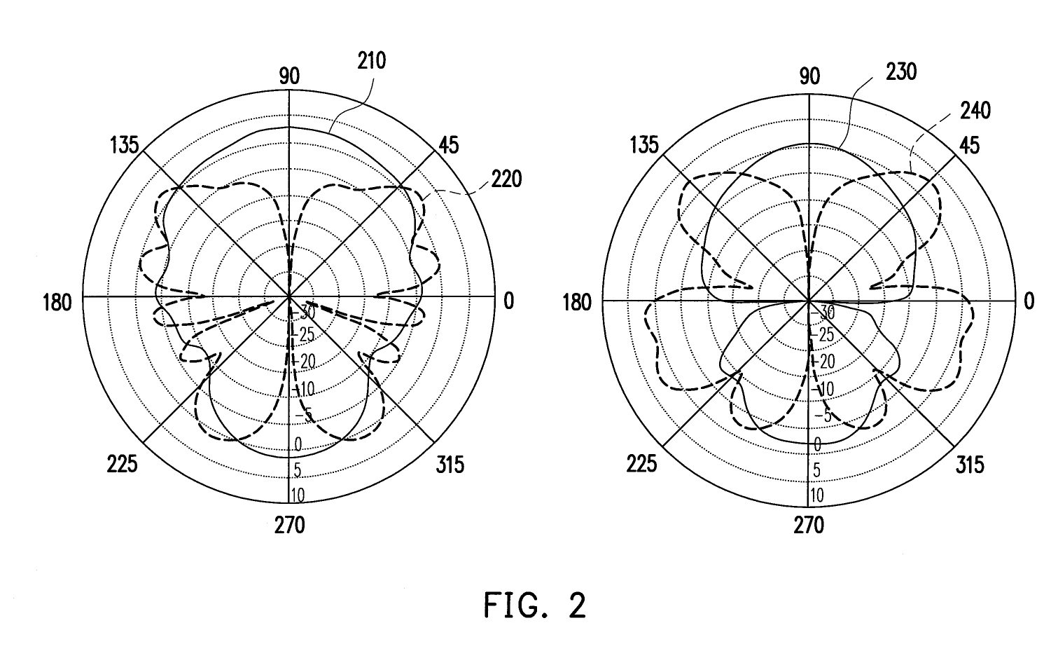

For instance, in the embodiment of FIG. 1, the radiation element 120 having an inverted-F antenna structure can be operated at resonant frequencies 2.4 GHz and 5.15 GHz through the two resonant modes, and the antenna 100 can improve the radiation pattern of the radiation element 120 at the resonant frequency 5.15 GHz by using the frequency selective structure 130. FIG. 2 is an radiation pattern diagram of an antenna according to an embodiment of the present invention, wherein FIG. 2 is the radiation patterns of the antenna 100 at the resonant frequency 5.15 GHz, and a left portion and a right portion of FIG. 2 are the radiation patterns of the antenna 100 disposed with the frequency selective structure 130, and disposed without the frequency selective structure 130, respectively. As shown in FIG. 2, curves 210 and 230 are antenna patterns of the antenna 100 in Z-Y plane, and curves 220 and 240 are antenna patterns of the antenna 100 in X-Y plane. In view of the curves 210 to 240, the radiation patterns of the antenna 100 are substantially improved due to disposition of the frequency selective structure 130.

Although an implementation of the radiation element 120 is illustrated in FIG. 1, but the present invention is not limited thereto. For instance, the implementation of the radiation element 120 can also be a radiation bodies with various types of antenna such as a monopole antenna, a dipole antenna, a loop antenna, and so on. In other words, the antenna 100 can improve the radiation patterns of the radiation element 120 in various types by using the frequency selective structure 130.

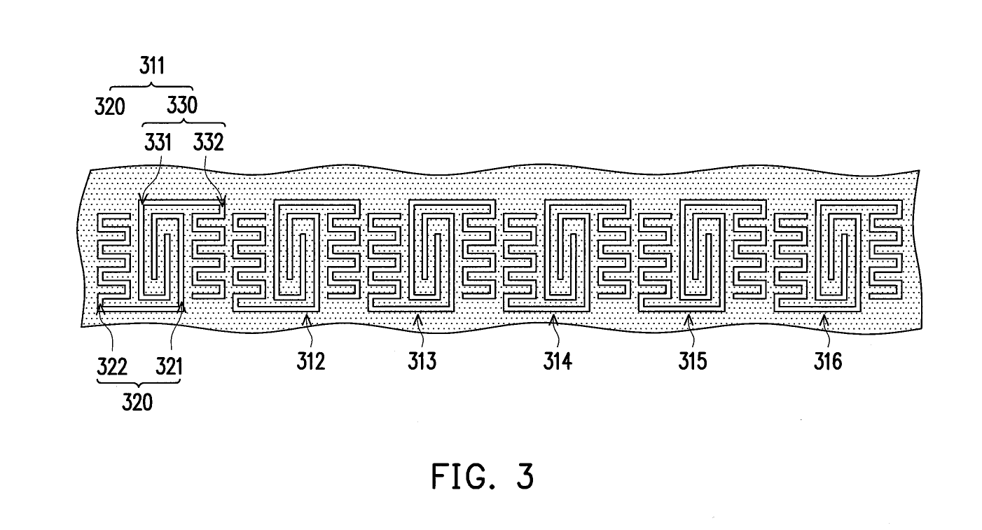

FIG. 3 is a schematic enlarged view of the frequency selective structure depicted in FIG. 1. The frequency selective structure 130 is further described with reference to FIG. 1 and FIG. 3. As shown in FIG. 3, the frequency selective structure 130 includes a plurality of frequency selective units, such as frequency selective units 311 to 316. As shown in FIG. 1, the frequency selective units in the frequency selective structure 130 are arranged along side edges SD2 to SD4 of the reflection area A1 except the side edge SD1, so as to form a periodic array located below the radiation element 120.

Each of the frequency selective units is resonated at the resonant frequency (e.g., 5.15 GHz) of the radiation element 120. Accordingly, due to a band-rejection filtering effect at the resonant frequency (e.g., 5.15 GHz) generated by the frequency selective structure 130, an electromagnetic wave radiated by the radiation element 120 at the resonant frequency (e.g., 5.15 GHz) cannot pass through the frequency selective structure 130. In other words, the frequency selective structure 130 can reflect the electromagnetic wave radiated by the radiation element 120 at the resonant frequency (e.g., 5.15 GHz), thereby improving a radiation pattern of the radiation element 120 at the resonant frequency (e.g., 5.15 GHz).

It should be noted that, each of the frequency selective units can form a capacitive resonance and an inductive resonance, so as to be resonated at the resonant frequency (e.g., 5.15 GHz) of the radiation element 120. For instance, in view of the frequency selective unit 311 depicted in FIG. 3 as an example, the frequency selective unit 311 includes a first slot 320 and a second slot 330, wherein the first slot 320 and the second slot 330 are both a closed slot. In addition, the first slot 320 and the second slot 330 penetrate the ground plane 110, and are arranged in rotational symmetry.

The first slot 320 includes a first slot line 321 and a second slot line 322. The first slot line 321 and the second slot line 322 respectively include a closed end and an open end, and the open end of the first slot line 321 and the open end of the second slot line 322 are connected to each other, so as to form the first slot 320. Similarly, the second slot 330 includes a third slot line 331 and a fourth slot line 332. The third slot line 331 and the fourth slot line 332 respectively include a closed end and an open end, and the open end of the third slot line 331 and the open end of the fourth slot line 332 are connected to each other, so as to form the second slot 330.

Moreover, the first slot line 321 and the third slot line 331 are alternately arranged to form the capacitive resonance, and the second slot line 322 and the fourth slot line 332 are respectively adapted to form the inductive resonance. In addition, a length of the first slot 320, which is a distance between the closed end of the first slot line 321 to the closed end of the second slot line 322, is a one-third the wavelength of the resonant frequency (e.g., 5.15 GHz) of the radiation element 120. Similarly, a length of the second slot 330 is also a one-third the wavelength of the resonant frequency (e.g., 5.15 GHz) of the radiation element 120. In addition, shapes of the first slot line 321 and the third slot line 331 can be, for example, a spiral shape or a paperclip shape, and shapes of the second slot line 322 and the fourth slot line 332 can be, for example, a meandering shape.

Referring back to FIG. 1, the antenna 100 further includes a substrate 140. The ground plane 110, the radiation element 120 and the frequency selective structure 130 are disposed on a surface of the substrate 140. In other words, the antenna 100 is equivalent to a planar antenna which is adapted to be disposed in an electronic device. In addition, the ground plane 110 of the antenna 100 is adapted to be disposed on a housing of the electronic device. For instance, the electronic device can be, for example, a desktop computer, a notebook computer, a tablet computer or a smart phone. In addition, for the desktop computer, the notebook computer or the tablet computer, the ground plane 110 of the antenna 100 can be disposed on a back cover behind a display panel. In contrast, for the smart phone, the ground plane 110 of the antenna 100 can be disposed on a housing, a back cover or a battery back cover of the smart phone.

Furthermore, the reflection area A1 of the ground plane 110 depicted in FIG. 1 is illustrated as a rectangular shape. Accordingly, as shown in FIG. 1, the side edge SD2 of the reflection area A1 is parallel to the side edge SD1, and a distance between the side edge SD2 and the side edge SD1 is the width WD1 of the reflection area A1. Although an implementation of the reflection area A1 is illustrated in FIG. 1, but the present invention is not limited thereto. For instance, the reflection area A1 can also be other geometric figures such as a trapezoid shape, a parallelogram, a hexagon and so on. In other words, the reflection area A1 at least includes two side edges which are parallel to each other, wherein one of the two side edges is aligned with the edge 111 of the ground plane 110, and the two side edges are adapted to define the width of the reflection area A1.

In summary, the frequency selective structure is disposed on the ground plane along a part of the side edges of the reflection area of the ground plane. In addition, the width of the reflection area of the ground plane is related to the resonant frequency of the radiation element of the antenna. Accordingly, the antenna can improve the radiation pattern of the radiation element at the resonant frequency by using the frequency selective structure, so as to effectively improve the reception quality of the antenna.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An antenna, comprising:
a ground plane, having a reflection area, wherein a first side edge of the reflection area is aligned with an edge of the ground plane;
a radiation element, disposed near the first side edge of the reflection area and operated at a resonant frequency, wherein a width of the reflection area is related to a wavelength of the resonant frequency; and
a frequency selective structure, disposed on the ground plane along side edges of the reflection area except the first side edge, and adapted to reflect an electromagnetic wave from the radiation element.

2. The antenna of claim 1, wherein a second side edge of the reflection area is parallel to the first side edge, and a distance between the second side edge and the first side edge is the width of the reflection area.

3. The antenna of claim 1, wherein the width of the reflection area is between a one-sixteenth the wavelength of the resonant frequency to a one-fourth the wavelength of the resonant frequency.

4. The antenna of claim 1, wherein the reflection area is surrounded by the radiation element and the frequency selective structure.

5. The antenna of claim 1, wherein the frequency selective structure comprises:
a plurality of frequency selective units, arranged along the side edges of the reflection area except the first side edge so as to form a periodic array, and each of the frequency selective units having a capacitive resonance and an inductive resonance, so as to be resonated at the resonant frequency of the radiation element.

6. The antenna of claim 5, wherein each of the frequency selective units comprises:
a first slot, penetrating the ground plane, and including a first slot line and a second slot line connected to each other; and
a second slot, penetrating the ground plane, and including a third slot line and a fourth slot line connected to each other,
wherein the first slot line and the third slot line are alternately arranged to form the capacitive resonance, and the second slot line and the fourth slot line are respectively adapted to form the inductive resonance.

7. The antenna of claim 6, wherein lengths of the first slot and the second slot are a one-third the wavelength of the resonant frequency.

8. The antenna of claim 6, wherein shapes of the first slot line and the third slot line are a spiral shape.

9. The antenna of claim 6, wherein shapes of the second slot line and the fourth slot line are a meandering shape.

10. The antenna of claim 1, wherein the antenna is adapted to be disposed on an electronic device, and the ground plane is adapted to be disposed on a housing of the electronic device.

11. The antenna of claim 1, wherein the frequency selective structure is resonated at the resonant frequency, and reflects an electromagnetic wave radiated by the radiation element at the resonant frequency.
